(19) United States
(12) Patent Application Publication
(10) Pub. No.: US 2013/0222334 A1
(43) Pub. Date: Aug. 29, 2013

(54) INFORMATION PROCESSING APPARATUS

(71) Applicant: Kenji TOKUTAKE, Kanagawa (JP)

(72) Inventor: Kenji TOKUTAKE, Kanagawa (JP)

(73) Assignee: Sony Mobile Communications Japan, Inc., Tokyo (JP)

(21) Appl. No.: 13/596,731

(22) Filed: Aug. 28, 2012

Related U.S. Application Data
(60) Provisional application No. 61/552,556, filed on Oct. 28, 2011.

(51) Int. Cl. G06F 3/044

(52) U.S. Cl. CPC G06F 3/044
USPC 345/174; 345/173

(57) ABSTRACT

An information processing apparatus including a display that displays a three-dimensional (3D) image including a left-eye image and a right-eye image; a sensor unit that detects a proximity operation of an object by detecting detection data corresponding to a distance between the sensor unit and the object; and a controller that adjusts a difference between the left-eye image and the right-eye image of the 3D image displayed by the display based on the detection data detected by the sensor unit.

### CROSS REFERENCE TO RELATED APPLICATION

The present application claims the benefit of the earlier filing date of U.S. Provisional Patent Application Ser. No. 61/552,556 filed on Oct. 28, 2011, the entire contents of which is incorporated herein by reference.

### BACKGROUND

1. Field of the Disclosure

The present disclosure relates to an ideal three dimensional (3D) image processing apparatus applied to an electronic device provided with an operable unit such as a touch panel, for example, which detects operation modes on the basis of changes in the capacitance of its operable surface, and also provided with 3D display functions which display 3D still images and/or 3D video.

Specifically, the present disclosure relates to an ideal 3D image processing apparatus applied to an electronic device such as such as a mobile phone, a PHS phone (PHS: Personal Handyphone System), a PDA (PDA: Personal Digital Assistant), a digital camera, a digital video camera, a portable game console, or a notebook computer, for example.

2. Description of Related Art

At present, mobile phones provided with capacitive touch panels are known, as disclosed Japanese Unexamined Patent Application Publication No. 2011-172078 (PTL 1) or Japanese Unexamined Patent Application Publication No. 2011-070525 (PTL 2), for example.

In such a mobile phone provided with a touch panel, a controller detects a direct touch operation via the touch panel on the basis of an input processing program. Then, the controller is configured to control execution of a process corresponding to the detected direct touch operation from among respective information processes in a given application program.

Also, a mobile phone provided with 3D still image or video display functions has been disclosed in Japanese Unexamined Patent Application Publication No. 2011-015133 (PTL 3) and Japanese Unexamined Patent Application Publication No. 2004-234614 (PTL 4), for example.

### SUMMARY

However, at present the amount of pop-out in a 3D image seen by a user is often an amount of pop-out that has been adjusted by the provider of that 3D image. For this reason, it has been difficult for a user to view a 3D image adjusted to his or her preferred amount of pop-out.

The inventor of the present disclosure has recognized the need for a 3D image processing apparatus in which the amount of pop-out in 3D images can be adjusted to a preferred amount of pop-out with simple operations.

According to a first exemplary embodiment, the disclosure is directed to an information processing apparatus including a display that displays a three-dimensional (3D) image including a left-eye image and a right-eye image; a sensor unit that detects a proximity operation of an object by detecting detection data corresponding to a distance between the sensor unit and the object; and a controller that adjusts a difference between the left-eye image and the right-eye image of the 3D image displayed by the display based on the detection data detected by the sensor unit.

According to another exemplary embodiment, the disclosure is directed to a method performed by an information processing apparatus, the method comprising: displaying, by a display of the information processing apparatus, a three-dimensional (3D) image including a left-eye image and a right-eye image; detecting, by a sensor unit of the information processing apparatus, a proximity operation of an object by detecting detection data corresponding to a distance between the sensor unit and the object; and adjusting, by a processor of the information processing apparatus, a difference between the left-eye image and the right-eye image of the 3D image displayed by the display based on the detection data detected by the sensor unit.

According to another exemplary embodiment, the disclosure is directed to a non-transitory computer-readable medium including computer program instructions, which when executed by an information processing apparatus, cause the information processing apparatus to perform a method comprising: displaying a three-dimensional (3D) image including a left-eye image and a right-eye image; detecting a proximity operation of an object by detecting detection data corresponding to a distance between the sensor unit and the object; and adjusting a difference between the left-eye image and the right-eye image of the 3D image based on the detection data.

According to such an embodiment of the present disclosure, the user performs a simple operation that merely adjusts the distance between a display surface and an operating object, and in so doing, the operation is automatically tracked and the amount of pop-out in a 31) image can be adjusted to a preferred amount of pop-out.

### BRIEF DESCRIPTION OF DRAWINGS

FIG. 1 is a block diagram of a mobile phone according to an embodiment to which the present disclosure has been applied.

FIG. 2 is a diagram illustrating exemplary installation positions of proximity sensors which are plurally provided on a mobile phone according to an embodiment.

FIG. 3 is a diagram illustrating respective operation layers which are virtually provided in the space above the display unit of a mobile phone according to an embodiment.

FIG. 4 is a function block diagram for when the controller of a mobile phone according to an embodiment acts on the basis of a 3D image processing program.

FIG. 5 is a flowchart for explaining 3D image processing action of a mobile phone according to an embodiment.

FIG. 6 is a diagram illustrating an exemplary capacitance map detected during a direct touch operation on a mobile phone according to an embodiment.

FIG. 7 is a diagram illustrating an exemplary capacitance map detected during a contactless operation on a mobile phone according to an embodiment.

FIGS. 8A and 8B are diagrams for explaining respective operation layers of a mobile phone according to an embodiment and the differences among capacitance values detected in each operation layer.

FIGS. 9A and 9B are diagrams for explaining the display position difference between left-eye and right-eye images and the amount of pop-out in a 3D image for the case where a contactless operation is performed in a first operation layer of a mobile phone according to an embodiment.

FIGS. 10A and 10B are diagrams for explaining the display position difference between left-eye and right-eye images and the amount of pop-out in a 3D image for the case where a contactless operation is performed in a third operation layer of a mobile phone according to an embodiment.

FIGS. 11A and 11B are diagrams for explaining the display position difference between left-eye and right-eye images and the amount of pop-out in a 3D image for the case where a contactless operation is performed in a first operation layer of a mobile phone according to an embodiment.

FIGS. 12A and 12B are diagrams for explaining the display position difference between left-eye and right-eye images and the amount of pop-out in a 3D image for the case where a contactless operation is performed in a third operation layer of a mobile phone according to an embodiment.

### DETAILED DESCRIPTION

The present disclosure may be applied to a mobile phone as an example.

### [Configuration of Mobile Phone]

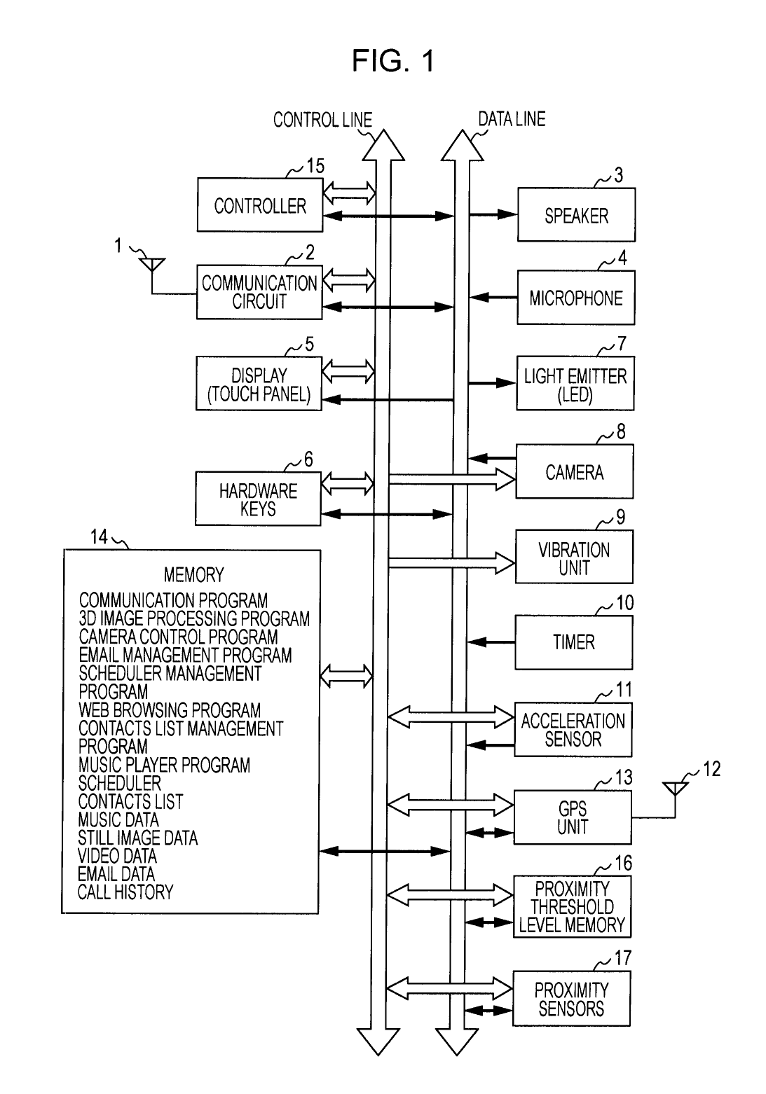

FIG. 1 is a block diagram of a mobile phone according to an embodiment of the present disclosure. As illustrated in FIG. 1, a mobile phone according to this embodiment includes an antenna 1 and a communication circuit 2 which conduct wireless communication such as audio telephony, video telephony, email, and Web data (Web: World Wide Web) with a base station.

Also, the mobile phone includes a speaker unit 3 for obtaining acoustic output such as telephone receiver audio, a microphone unit 4 for picking up telephone transmitter audio, etc., a display unit 5 forming what is called a touch panel for performing direct touch operations and contactless operations to be later described thereon, and a plurality of hardware keys 6 physically provided on the chassis of the mobile phone.

The mobile phone also includes a light emitter 7 (LED: Light Emitting Diode) for notifying the user of incoming/outgoing signals, etc. with light, a camera unit 8 for shooting a still image or video of a desired subject, a vibration unit 9 for notifying the user of incoming/outgoing signals, etc. by causing the chassis of the mobile phone to vibrate, and a timer 10 that keeps the current time.

The mobile phone also includes an acceleration sensor 11 for detecting shake operations, etc. imparted to the chassis of the mobile phone, as well as a GPS antenna 12 (GPS: Global Positioning System) and a GPS unit 13 for detecting the present location of the mobile phone and the shooting location of still images or videos shot with the camera unit 8.

The mobile phone also includes memory 14 storing a communication program for conducting the wireless communication processing via a base station and various application programs in addition to various data handled by these various application programs, and a controller 15 that controls overall action of the mobile phone.

The mobile phone also includes contactless threshold level memory 16 that stores a plurality of threshold levels for detecting the distance between the display surface of the display unit 5 and an operating object such as the user's finger.

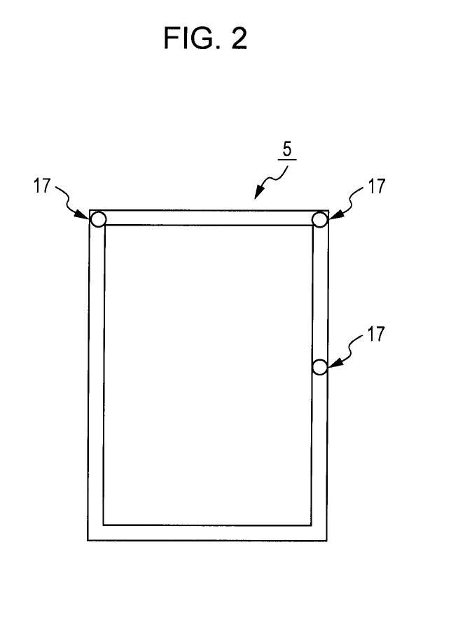

The mobile phone also includes proximity sensors 17 respectively provided at three given locations on the chassis of the mobile phone as illustrated in FIG. 2, for example.

A projected capacitive touch panel is provided as the touch panel of the display unit 5. The projected capacitive touch panel includes a resistive film with an electrode layer underneath, as well as a substrate layer provided with a control IC (control integrated circuit).

In the electrode layer underneath the resistive film, many electrode patterns forming a mosaic consisting of two layers (horizontal and vertical) are arranged on a glass, plastic, or other substrate using transparent electrodes such as indium tin oxide (ITO).

The projected capacitive touch panel identifies an operation position by detecting changes in electrode capacitance due to a direct touch operation or a contactless operation from two (horizontal and vertical) electrode lines. By respectively providing many electrode lines in the horizontal and vertical directions, multipoint detection of direct touch operations becomes possible.

Although a projected capacitive touch panel is provided as the display unit 5 in this example, what is called a surface capacitive touch panel may also be provided instead of the projected capacitive touch panel.

Besides the communication program, the memory 14 stores a 3D image processing program which conducts 3D image display processing according to three-dimensional contactless operations on the display unit 5 forming the touch panel.

Also stored in the memory 14 is a camera control program for controlling the shooting of still images or video with the camera unit 8. The camera control program is provided with a viewer program for displaying shot still images on the display unit 5, etc. The viewer program is provided with functions for changing the display magnification by enlarging or reducing a displayed image, and facial recognition functions for detecting facial images of subjects (persons) appearing in still images.

The camera control program is also provided with a video playback program for displaying shot videos on the display unit 5, etc. Also, the video playback program is provided with playback speed modification functions for controlling changes to the video playback speed.

Also stored in the memory 14 are an email management program for controlling the creation and transmitting/receiving of email, and a scheduler management program for managing a scheduler in which the user's schedule is registered.

Also stored in the memory 14 are a Web browsing program for viewing Web pages by transmitting/receiving information by accessing a server provided on a given network such as a communication network or the Internet, a contacts list management program for managing a contacts list that registers personal information such as the names, addresses, telephone numbers, email addresses, and facial photos of friends and acquaintances (i.e., the contacts list is a personal information registration area), and a music player program for playing back music data.

Also stored in the memory 14 is a scheduler in which the user's desired schedule is registered (i.e., a schedule data registration area), and a contacts list in which information such as the user names, still images (facial images, etc.), addresses, telephone numbers, email addresses, and birthdates of the user's friends and acquaintances is registered (i.e., a personal information registration area for respective users).

Also stored in the memory 14 are music data played back by the music player program, still image data and video data played back by the viewer program and video playback program in the camera control program, transmitted/received email data, and a history of transmitted/received telephone calls and emails.

Next, in the case of this mobile phone, “direct touch operations” are detected, such operations being performed by causing a finger or other operating element (conductive member) to contact the operable surface of the display unit 5 which forms a projected capacitive touch panel.

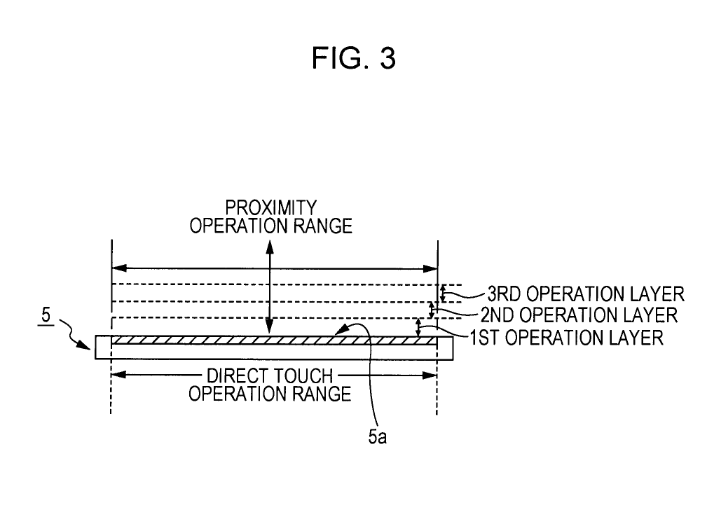

Also, in the case of this mobile phone, it is configured such that “contactless operations” are detected, such operations being performed by causing a finger or other conductive member to move over the operable surface of the display unit 5 such that the distance between the operable surface of the display unit 5 and the finger as illustrated in FIG. 3 is short enough to cause at least a given change in the capacitance of the display unit 5, but without the finger directly touching the operable surface.

Capacitance values detected by the display unit 5 change according to the distance between the operable surface 5a and the operating element. A mobile phone in this embodiment includes a plurality of threshold levels respectively corresponding to respective distances between the operable surface 5a and the operating element. Furthermore, it is configured such that the distance between the operable surface 5a and the operating element during a contactless operation is detected by comparing capacitance values detected by the display unit 5 to the respective threshold levels.

In other words, in the case of a mobile phone in this embodiment, the space above the display unit 5 becomes virtually divided into a total of three contactless operation layers according to the distance between the operable surface 5a and the operating element: a first operation layer, a second operation layer, and a third operation layer in order of nearness to the operable surface 5a of the display unit 5, as illustrated in FIG. 3, for example.

When displaying a 3D image, the controller 15 acts on the basis of the 3D image processing program stored in the memory 14 to adjust the difference in the respective display positions of left-eye image information and right-eye image information (i.e., the offset between the respective display positions) to a difference between the respective display positions that corresponds to the distance between the operable surface 5a and the operating element. Then, the convergence point, which is the intersection between the respective lines of vision from the user's eyes, is moved towards the operable surface or away from the operable surface and a 3D image having an amount of pop-out corresponding to the operation layer where the user's finger is positioned is created and displayed.

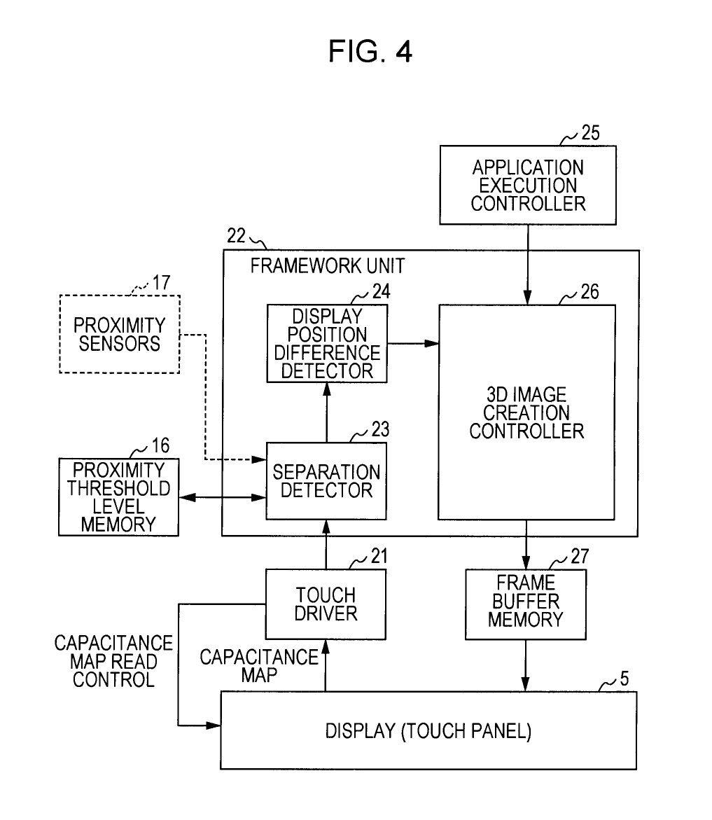

FIG. 4 illustrates a function block diagram of the controller 15 which is realized as a result of the controller 15 acting on the basis of the 3D image processing program.

As illustrated in FIG. 4, in the case of acting on the basis of the 3D image processing program, the controller 15 functions as a touch driver 21 that acquires from the display unit 5 a capacitance map which expresses the capacitance values of all sensors in the display unit 5 forming a touch panel.

Also, in the case of acting on the basis of the 3D image processing program, the controller 15 functions as a separation detector 23 of a framework unit 22 which detects the operation layer where the user's finger, etc. is currently positioned on the basis of the capacitance map acquired from the display unit 5.

Also, in the case of acting on the basis of the 3D image processing program, the controller 15 functions as a display position difference detector 24 which detects the difference between the respective display positions of the respective left-eye and right-eye image information corresponding to the distance between the operable surface 5a and the operating element (i.e., the operation layer) detected when the controller 15 functioned as the separation detector 23.

Also, when acting on the basis of the 3D image processing program, the controller 15 functions as a 3D image creation controller 26 which creates 3D images corresponding to respective processes in the currently activated application program.

In other words, the controller 15 functions as the 3D image creation controller 26 to create left-eye images and right-eye images from images corresponding to respective processes in an application program whose execution is being controlled as a result of the controller 15 functioning as an application execution controller 25. Furthermore, the controller 15 creates 3D images having the detected display position difference on the basis of the left-eye images and right-eye images. Although discussed later, 3D images created in this way are displayed on the display unit 5 via frame buffer memory 27.

### [3D Image Display Action]

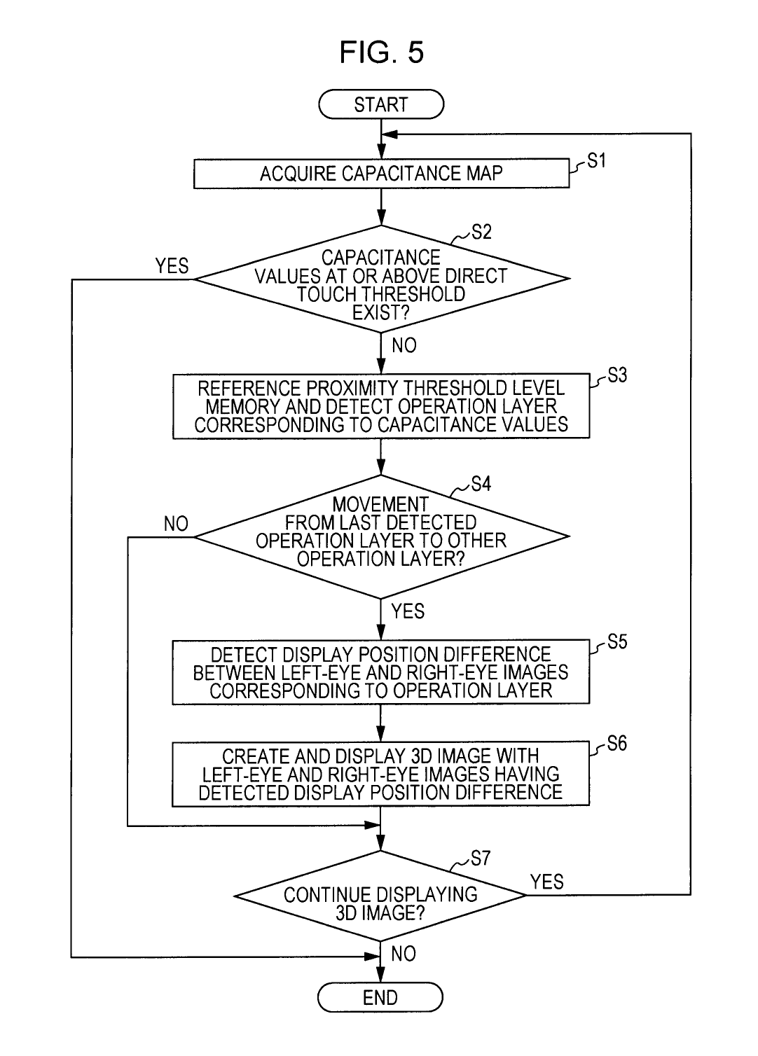

FIG. 5 illustrates a flowchart of 3D image display action by the controller 15. When the controller 15 display images on the display unit 5, such as in the case of displaying images corresponding to respective processes in the currently active application program, for example, the controller 15 initiates the process illustrated by the flowchart in FIG. 5 on the basis of the 3D image processing program stored in the memory 14.

First, upon advancing the process to step S1 of the flowchart, the controller 15 functions as the touch driver 21, acquires a capacitance map expressing capacitance values detected from all sensors in the display unit 5 forming a capacitive touch panel, and advances the process to step S2.

In step S2, the controller 15 continues to function as the touch driver 21 to compare the capacitance values of the acquired capacitance map to a direct touch threshold level for determining a direct touch operation performed by causing a finger or other operating object to contact the operable surface 5a of the display unit 5. In so doing, the controller 15 determines whether or not there exist capacitance values equal to or greater than the direct touch threshold level among the capacitance values detected by all sensors in the display unit 5.

The existence of capacitance values equal to or greater than the direct touch threshold level among the capacitance values detected by all sensors in the display unit 5 means that a direct touch operation is currently being performed on the display unit 5 by the user. In this case, the controller 15 ends the process of the flowchart in FIG. 5 and controls execution of a process in the currently activated application program on the basis of direct touch operation performed by the user.

In contrast, a lack of capacitance values equal to or greater than the direct touch threshold level among the capacitance values detected by all sensors in the display unit 5 means that a contactless operation is currently being performed by the user. In this case, the controller 15 advances the process to step S3.

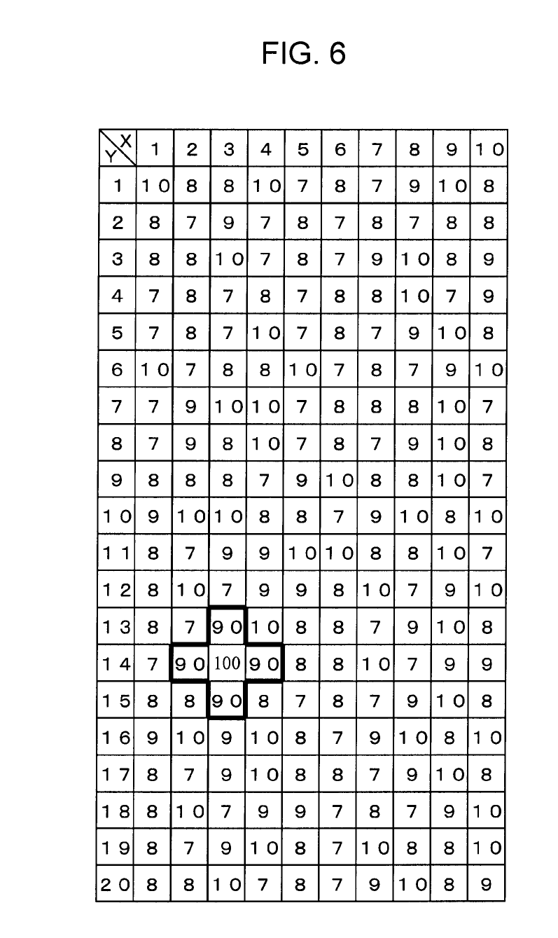

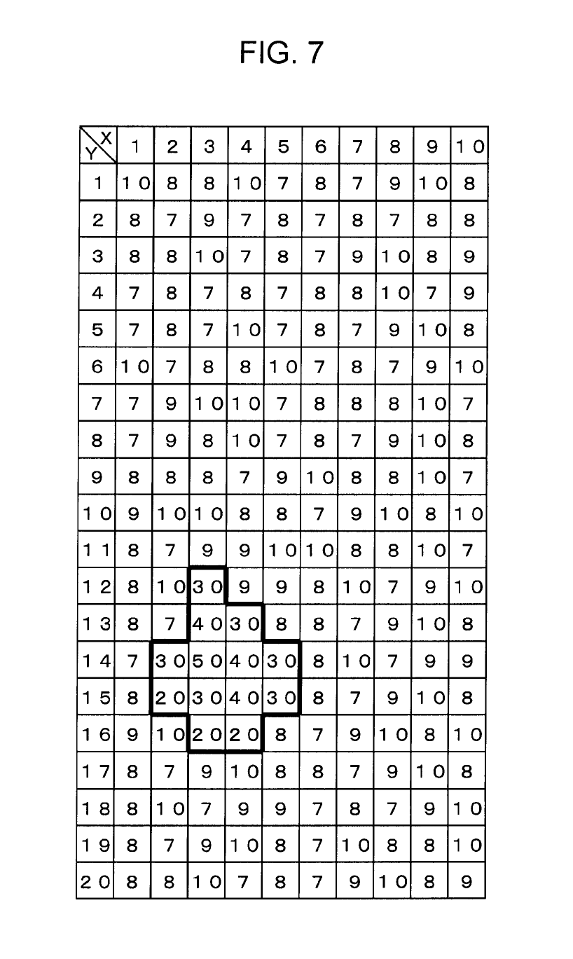

The process up to this point will be explained in further detail. FIG. 6 illustrates a capacitance map during a direct touch operation acquired from the display unit 5, while FIG. 7 illustrates a capacitance map during a contactless operation acquired from the display unit 5.

During a direct touch operation, only the capacitance value of the site that was directly touched and the capacitance values of the immediately adjacent sites become large capacitance values, as indicated by being enclosed in bold lines in FIG. 6. In contrast, during a contactless operation, capacitance values change to intermediate values over a wider range than during a direct touch operation, as indicated by being enclosed in bold lines in FIG. 7.

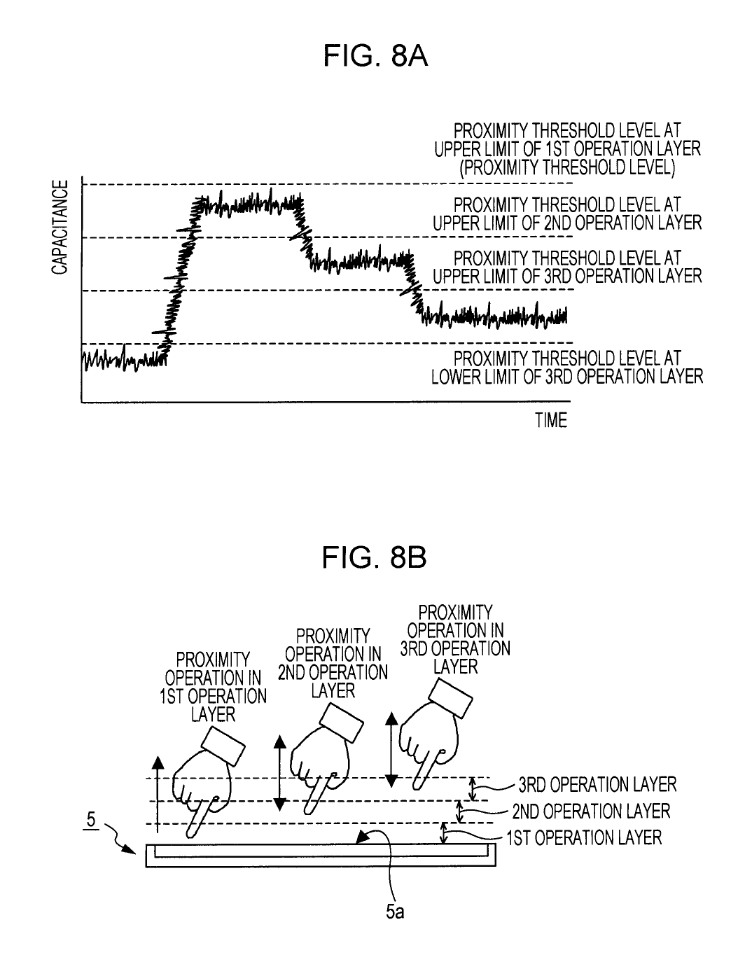

Regarding the threshold levels, the threshold level for detecting the direct touch operation is set to the highest value, as illustrated in FIG. 8A. In the case where the controller 15 detects the existence of capacitance values equal to or greater than the direct touch threshold level among the respective capacitance values in a capacitance map acquired from the display unit 5, the controller 15 determines that a direct touch operation is currently being performed on the display unit 5 as discussed earlier, ends the process of the flowchart in FIG. 5, and controls execution of a process in the currently activated application program on the basis of the direct touch operation performed by the user.

Also, a mobile phone in this embodiment includes a plurality of threshold levels corresponding to distances between the operable surface 5a and an operating element during contactless operations.

In other words, if a contactless operation is conducted in order from the first operation layer to the second operation layer to the third operation layer as illustrated in FIG. 8B, then the user's finger is gradually becoming more distant from the operable surface 5a of the display unit 5. Furthermore, as the distance increases between the user's finger and the operable surface 5a, the capacitance values detected by the respective sensors of the display unit 5 gradually become smaller values. Respective contactless threshold levels are individually set for the respective operation layers according to the distance between the operable surface 5a and an operating element as illustrated in FIG. 8A, such that capacitance values are detected in ranges corresponding to such respective operation layers.

Next, upon advancing the process to step S3 of the flowchart in FIG. 5, the controller 15 functions as the separation detector 23 of the framework unit 22 to compare the capacitance values detected in step S2 to respective threshold levels stored in the contactless threshold level memory 16. In so doing, the controller 15 detects the operation layer corresponding to the capacitance values, i.e., the operation layer in which the user is currently performing a contactless operation.

Specifically, in the case where the capacitance values detected in step S2 are values between the threshold level forming the upper limit of the first operation layer and the threshold level forming the upper limit of the second operation layer illustrated in FIG. 8A, the controller 15 determines that the operation layer in which a contactless operation is currently being performed is the first operation layer.

Similarly, in the case where the capacitance values detected in step S2 are values between the threshold level forming the upper limit of the second operation layer and the threshold level forming the upper limit of the third operation layer illustrated in FIG. 8A, the controller 15 determines that the operation layer in which a contactless operation is currently being performed is the second operation layer.

Similarly, in the case where the capacitance values detected in step S2 are values between the threshold level forming the upper limit of the third operation layer and the threshold level forming the lower limit of the third operation layer illustrated in FIG. 8A, the controller 15 determines that the operation layer in which a contactless operation is currently being performed is the third operation layer.

At this point, although discussed later, a mobile phone in this embodiment is configured to automatically track movement among operation layers by a contactless operation and control modification of the amount of pop-out in a 3D image. For this reason, upon detecting the operation layer in which a contactless operation is currently being performed in step S3, this operation layer is compared to an operation layer that was detected immediately prior to detecting this operation layer, and any movement among operation layers by a contactless operation is detected.

However, at the stage where an operation layer is being detected for the first time, an operation layer that was detected immediately prior to detecting this operation layer does not exist (i.e., a previously detected operation layer does not exist). For this reason, the controller 15 skips the processing in step S4 and advances the process to step S5 in such cases.

In step S5, the controller 15 functions as the display position difference detector 24 to detect the difference between the display position of a right-eye image and the display position of a left-eye image in accordance with the operation layer detected in step S3. The controller 15 advances the process to step S6.

In other words, in step S5, the controller 15 functions as the display position difference detector 24 to detect the difference between the display position of a left-eye image and the display position of a right-eye image which corresponds to the distance between the operable surface 5a and the operating element detected in step S3. The controller 15 advances the process to step S6.

Specifically, a mobile phone in this embodiment is configured such that the difference between the display positions of the respective images is adjusted to the smallest display position difference in the case where the operation layer of a contactless operation is the first operation layer, i.e., the operation layer closest to the operable surface 5a of the display unit 5.

Also, a mobile phone in this embodiment is configured such that the difference between the display positions of the respective images is adjusted to the largest display position difference in the case where the operation layer of a contactless operation is the third operation layer, i.e., the operation layer farthest from the operable surface 5a of the display unit 5.

Also, a mobile phone in this embodiment is configured such that the difference between the display positions of the respective images is adjusted to an intermediate degree in the case where the operation layer of a contactless operation is the second operation layer, i.e., the middle operation layer between the first operation layer and the third operation layer.

Next, the controller 15 advances the process to step S6 and functions as the 3D image creation controller 26 to create respective left-eye and right-eye image information on the basis of image information corresponding to respective processes in an application program being executed as a result of the controller 15 functioning as the application execution controller 25 illustrated in FIG. 4.

Then, the controller 15 controls writing of the respective left-eye and right-eye image information to the frame buffer memory 27 such that this respective left-eye and right-eye image information has a display position difference corresponding to the operation layer of the contactless operation. Thus, 3D image information in which respective left-eye and right-eye image information has the above display position difference is written to the frame buffer memory 27.

Such 3D image information that has been written to the frame buffer memory 27 is read out at given timings and its display on the display unit 5 is controlled by the controller 15.

The magnitude of the display position difference between the respective left-eye and right-eye image information is roughly proportional to the distance between the convergence point, which is the intersection between the lines of vision from the user's eyes, and the operable surface 5a of the display unit 5. Furthermore, the user sees display objects being displayed on the display unit 5 gradually pop out more as the distance between the convergence point and the operable surface 5a of the display unit 5 increases (the amount of pop-out increases for display objects being displayed on the display unit 5).

For this reason, by adjusting the display position difference between the respective images in accordance with the operation layer of a contactless operation detected in step S3, the convergence point can be moved to a position corresponding to the operation layer of the contactless operation and the amount of pop-out for display objects displayed on the display unit 5 can be made to be an amount of pop-out corresponding to the operation layer in which a contactless operation is performed.

In other words, the amount of pop-out for display objects displayed on the display unit 5 can be easily made to be a desired amount of pop-out with a configuration in which the distance between the operable surface 5a of the display unit 5 and an operating element is automatically tracked as a result of the user performing a contactless operation that separates the operable surface 5a and the operating element by a desired distance.

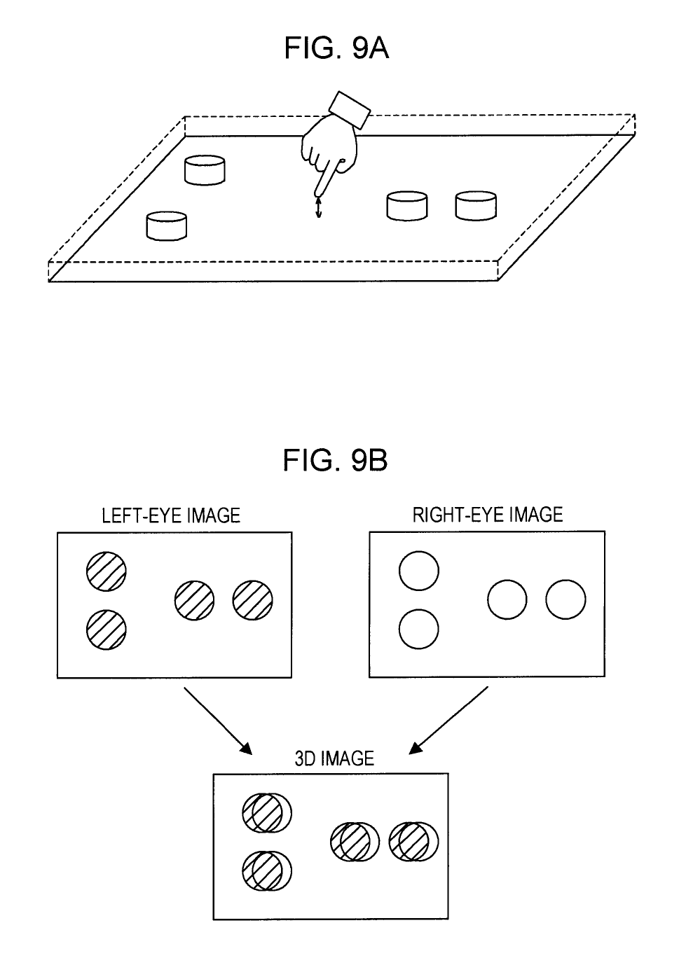

To explain more specifically, if a contactless operation is performed in the first operation layer, i.e., the operation layer closest to the operable surface 5a of the display unit 5, as illustrated in FIG. 9A, the controller 15 adjusts the display position difference so as to decrease the display position difference between a left-eye image and a right-eye image, as illustrated in FIG. 9B.

If the display position difference between a left-eye image and a right-eye image is adjusted and decreased, the convergence point for the user is positioned closer to the operable surface 5a of the display unit 5, and the user will view a display image with a lesser amount of pop-out, as illustrated in FIG. 9A.

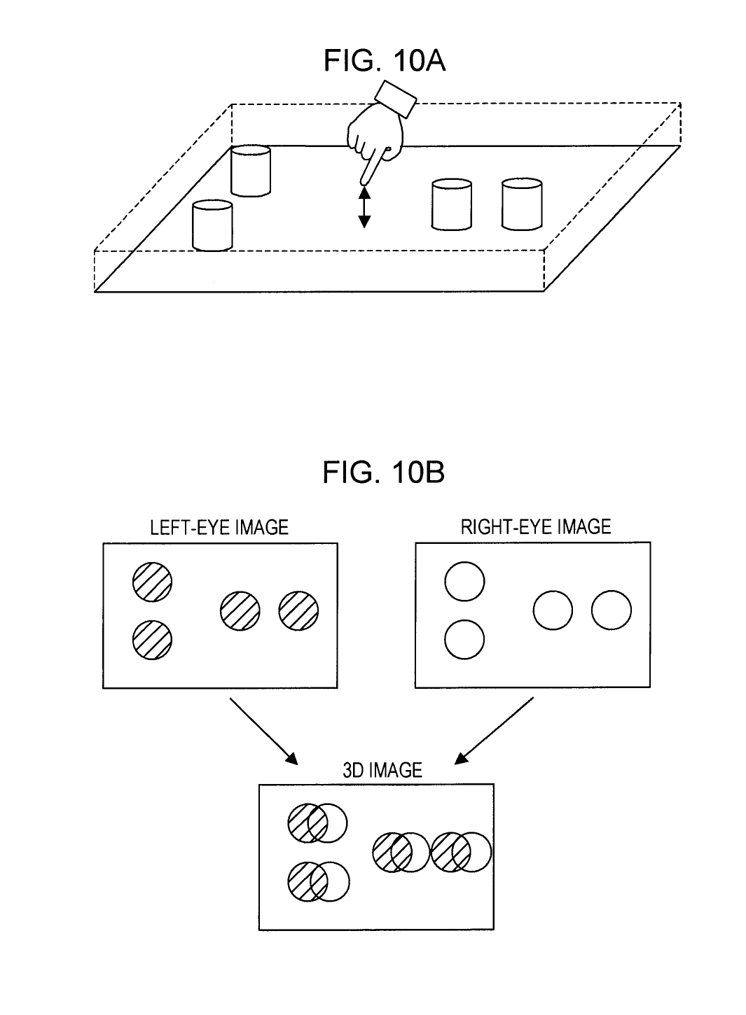

Conversely, if a contactless operation is performed in the third operation layer, i.e., the operation layer farthest from the operable surface 5a of the display unit 5, as illustrated in FIG. 10A, the controller 15 adjusts the display position difference so as to increase the display position difference between a left-eye image and a right-eye image, as illustrated in FIG. 10B.

If the display position is adjusted to as to increase the display position difference between a left-eye image and a right-eye image, the convergence point for the user is positioned farther from the operable surface 5a of the display unit 5, and the user will view a display image with a greater amount of pop-out, as illustrated in FIG. 10A.

Stated differently, in the case of a mobile phone in this embodiment, the controller 15 adjusts the display position difference between a left-eye image and a right-eye image in accordance with the distance from the operable surface 5a of the display unit 5 to a contactless operation position, and adjusts the amount of pop-out in a display image displayed on the display unit 5.

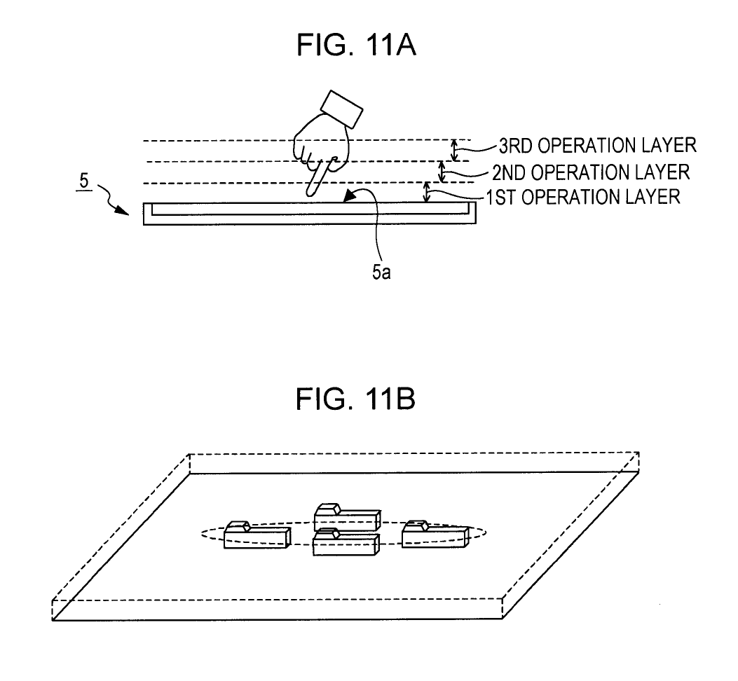

In other words, the controller 15 decreases the display position difference between a left-eye image and a right-eye image in the case where the distance from the operable surface 5a of the display unit 5 to a contactless operation position is short, as illustrated in FIG. 11A. In so doing, the amount of pop-out in a display image displayed on the display unit 5 is also decreased, as illustrated in FIG. 11B.

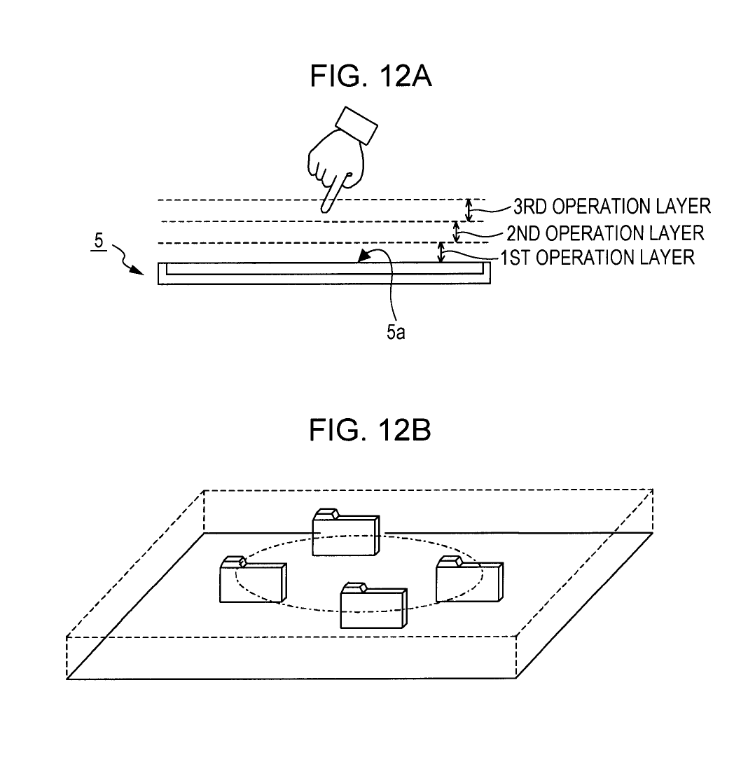

Conversely, the controller 15 increases the display position difference between a left-eye image and a right-eye image in the case where the distance from the operable surface 5a of the display unit 5 to a contactless operation position is long, as illustrated in FIG. 12A. In so doing, the amount of pop-out in a display image displayed on the display unit 5 is also increased, as illustrated in FIG. 12B.

Next, if the amount of pop-out in display objects being displayed on the display unit 5 is adjusted to an amount of pop-out corresponding to a contactless operation in this way, the controller 15 advances the process to step S7 of the flowchart in FIG. 5.

In step S7, the controller 15 determines whether or not an application program corresponding to an image being displayed on the display unit 5 is still currently running, and thereby determines whether or not to continue 3D image display.

Then, in the case where it is determined that the 3D image display has been terminated, such as in the case where an operation ending the currently activated application program has been performed, for example, the controller 15 ends all processing of the flowchart illustrated in FIG. 5.

In contrast, if the controller 15 determines to continue 3D image display, the controller 15 returns the process to step S1 and scans the capacitance values of all sensors on the display unit 5 as discussed earlier. If the capacitance map obtained by the scan includes capacitance values which are lower than the direct touch threshold level, then in step S3 the controller 15 detects, on the basis of the capacitance values, the operation layer in which the user is performed a contactless operation (i.e., detects the distance between operable surface 5a and the operating element).

Then, in step S4, the operation layer detected in step S3 is compared to the last detected operation layer before this operation layer (i.e., the operation layer detected by the last routine), and any movement among operation layers is determined.

In other words, in the case where the last detected operation layer is the first operation layer and the next detected operation layer is also the first operation layer, the controller 15 determines that there is no movement among operation layers and advances the process from step S4 to step S7.

Thus, in the case of no movement among operation layers, the amount of pop-out in display objects being displayed on the display unit 5 is maintained at the current amount of pop-out.

In contrast, in the case where the last detected operation layer is the first operation layer and the next detected operation layer is the second operation layer, the controller 15 determines that movement among operation layers has been performed and advances the process from step S4 to step S5.

Thus, the amount of pop-out in display objects being displayed on the display unit 5 is controlled and modified to an amount of pop-out corresponding to the second operation layer as discussed earlier.

Even if the user intends to stop his or her finger at the same position, the distance from the operable surface 5a to the user's finger changes due to vibration, shaking, etc. For this reason, if the amount of pop-out is adjusted in strict accordance with the distance from the operable surface 5a of the display unit 5 to the user's finger, unwanted behavior will occur in which the amount of pop-out in display objects changes frequently, even if the user is stopping his or her finger at the same position.

For this reason, it is preferable to adjust the amount of pop-out upon detecting movement of at least a given distance, such as adjusting the amount of pop-out upon detecting movement among operation layers as in a mobile phone in this embodiment, for example. In so doing, the distance between the operable surface 5a and an operating element can be automatically tracked, and in addition, stable adjustment control of the amount of pop-out becomes possible.

### Advantages of Embodiment

As the foregoing explanation demonstrates, a mobile phone in this embodiment creates and displays 3D images in which the display position difference between a left-eye image and a right-eye image has been adjusted in accordance with the distance between the operable surface 5a of a display unit 5 forming a capacitive touch panel and an operating element.

As an example, the space above the display unit 5 may be divided into three or another plurality of operation layers and the operation layer in which a contactless operation is being performed may be detected on the basis of different capacitance values for each individual operation layer, for example. 3D images are then created and displayed, in which the display position difference between a left-eye image and a right-eye image has been adjusted in accordance with the detected operation layer.

By adjusting the display position difference between a left-eye image and a right-eye image in accordance with the operation layer in which a contactless operation is being performed, the position of the convergence point at which the lines of vision from the user's eyes intersect can be moved towards the operable surface 5a of the display unit 5 or away from the display unit 5 in accordance with the operation layer in which the contactless operation is being performed.

Thus, the amount of pop-out in display objects being displayed on the display unit 5 can be adjusted with a configuration that automatically tracks a simple operation of simply moving the operation layer where a contactless operation is performed.

### Modifications

The foregoing embodiment was an example in which the operation layer where a contactless operation is being performed (i.e., the distance between the operable surface 5a and an operating element) is detected on the basis of the capacitance values of the display unit 5, and display objects being displayed on the display unit 5 are adjusted to an amount of pop-out that corresponds to the detected operation layer.

The amount of pop-out in display objects may also be adjusted according to the distance between the user's finger and the display unit 5 as detected by the plurality of proximity sensors 17 indicated in FIG. 2 and by broken lines in FIG. 4.

In other words, as described using FIG. 2, in the case of a mobile phone in this embodiment, a total of three proximity sensors 17 are provided on the chassis. Of these proximity sensors, a first proximity sensor is a proximity sensor that detects when an operating object such as the user's finger is positioned within a range corresponding to the first operation layer discussed earlier.

Similarly, a second proximity sensor is a proximity sensor that detects when an operating object such as the user's finger is positioned within a range corresponding to the second operation layer discussed earlier, and a third proximity sensor is a proximity sensor that detects when an operating object such as the user's finger is positioned within a range corresponding to the third operation layer discussed earlier.

In the case where the controller 15 obtains output from the first proximity sensor detecting that the user's finger is positioned within a range corresponding to the first operation layer, the controller 15 adjusts the display position difference between respective left-eye and right-eye images to a small display position difference like that illustrated in FIG. 9B. In so doing, display objects with a small amount of pop-out as illustrated in FIG. 9A can be displayed.

Also, in the case where the controller 15 obtains output from the third proximity sensor detecting that the user's finger is positioned within a range corresponding to the third operation layer, the controller 15 adjusts the display position difference between respective left-eye and right-eye images to a large display position difference like that illustrated in FIG. 10B. In so doing, the amount of pop-out in display objects can be increased as illustrated in FIG. 10A.

However, it is still preferable to adjust the amount of pop-out upon detecting movement of at least a given distance, even in the case of using a plurality of proximity sensors to adjust the amount of pop-out in display objects in this way.

Herein, the user's finger may also be shot using the camera unit 8 during a contactless operation, the shot image may be analyzed to detect the distance between the user's finger and the operable surface 5a of the display unit 5, and the amount of pop-out may be adjusted according to the detected distance.

However, in this case, since it is necessary to analyze a shot image, processing is complex and time-consuming, and there is a risk of reduced accuracy.

In contrast, in the case of the technique of detecting the distance between the user's finger and the operable surface 5a of the display unit 5 with a plurality of proximity sensors 17 discussed above, the amount of pop-out discussed earlier can be adjusted on the basis of “0” (indicating that a finger is not positioned in a relevant operation layer) or “1” (indicating that a finger is positioned in a relevant operation layer) information from the respective proximity sensors 17.

For this reason, the technique using the proximity sensors 17 enables adjustment of the amount of pop-out with processing that is simpler, faster, and more accurate than the technique using the camera unit 8. Moreover, the same advantages as those of the foregoing embodiment can be obtained.

According to the disclosure above, there is provided:

(1) An information processing apparatus comprising: a display that displays a three-dimensional (3D) image including a left-eye image and a right-eye image; a sensor unit that detects a proximity operation of an object by detecting detection data corresponding to a distance between the sensor unit and the object; and a controller that adjusts a difference between the left-eye image and the right-eye image of the 3D image displayed by the display based on the detection data detected by the sensor unit.

(2) The information processing apparatus of (1), wherein the sensor unit is a touch panel disposed on a surface of the display that detects an electrostatic capacitance as the detection data.

(3) The information processing apparatus of (2), wherein the controller determines the distance between the sensor unit and the object based on the detected electrostatic capacitance.

(4) The information processing apparatus of any one of (2) and (3), wherein the touch panel includes a substrate layer including an insulator film, an electrode layer arranged below the insulator film, and a control integrated circuit.

(5) The information processing apparatus of (4), wherein the touch panel includes a plurality of mosaic electrode patterns each including two layers of transparent electrodes in each of vertical and horizontal directions in the electrode layer.

(6) The information processing apparatus of any one of (1) to (5), wherein the sensor unit includes a plurality of proximity sensors disposed on an exterior surface of the information processing apparatus.

(7) The information processing apparatus of (6), wherein the detection data indicates that the object is detected by at least one of the plurality of proximity detectors.

(8) The information processing apparatus of (7), wherein the controller determines the distance between the sensor unit and the object based on the detection data indicating that the object is detected by at least one of the plurality of proximity detectors.

(9) The information processing apparatus of any one of (1) to (8), further comprising: a memory that stores a plurality ranges corresponding to the detection data, each of the ranges corresponding to one of a plurality of operation layers corresponding to the proximity operation.

(10) The information processing apparatus of (9), wherein the controller determines an operation layer corresponding to the proximity operation by comparing the detected detection data to each of the plurality of ranges stored by the memory.

(11) The information processing apparatus of (10), wherein the controller adjusts the difference between the left-eye image and the right-eye image of the 3D image displayed by the display based on the determined operation layer.

(12). The information processing apparatus of (10) or (11), wherein a first range of the detection data corresponds to a first operation layer and a second range of the detection data corresponds to a second operation layer, and the first range of detection data indicates that the distance between the sensor unit and the object is less than the distance between the sensor unit and the object indicated by the second range of detection data.

(13) The information processing apparatus of (12), wherein the controller adjusts the distance between the left-eye image and the right-eye image to be a first distance when the controller determines the operation layer to be the first operation layer and adjusts the distance between the left-eye image and the right-eye image to be a second distance when the controller determines the operation layer to be the second operation layer.

(14) The information processing apparatus of (13), wherein the first distance is less than the second distance.

(15) The information processing apparatus of any one of (1) to (10), wherein a first range of detection data corresponds to a first operation layer, a second range of detection data corresponds to a second operation layer, and a third range of detection data corresponds to a third operation layer, the first range of detection data indicates that the distance between the sensor unit and the object is less than the distance between the sensor unit and the object indicated by the second range of detection data, and the second range of detection data indicates that the distance between the sensor unit and the object is less than the distance between the sensor unit and the object indicated by the third range of detection data.

(16) The information processing apparatus of (15), wherein the controller adjusts the distance between the left-eye image and the right-eye image to be a first distance when the controller determines the operation layer to be the first operation layer, adjusts the distance between the left-eye image and the right-eye image to be a second distance when the controller determines the operation layer to be the second operation layer, and adjusts the distance between the left-eye image and the right-eye image to be a third distance when the controller determined the operation layer to be the third operation layer.

(17) The information processing apparatus of (16), wherein the first distance is less than the second distance and the second distance is less than the third distance.

(18) A method performed by an information processing apparatus, the method comprising: displaying, by a display of the information processing apparatus, a three-dimensional (3D) image including a left-eye image and a right-eye image; detecting, by a sensor unit of the information processing apparatus, a proximity operation of an object by detecting detection data corresponding to a distance between the sensor unit and the object; and adjusting, by a processor of the information processing apparatus, a difference between the left-eye image and the right-eye image of the 3D image displayed by the display based on the detection data detected by the sensor unit.

(19) A non-transitory computer-readable medium including computer program instructions, which when executed by an information processing apparatus, cause the information processing apparatus to perform a method comprising: displaying a three-dimensional (3D) image including a left-eye image and a right-eye image; detecting a proximity operation of an object by detecting detection data corresponding to a distance between the sensor unit and the object; and adjusting a difference between the left-eye image and the right-eye image of the 3D image based on the detection data.

Although the foregoing embodiment was an example wherein the present disclosure was applied to a mobile phone, the present disclosure may also be applied to other electronic devices provided with a touch panel besides a mobile phone, such as a PHS phone (PHS: Personal Handyphone System), a PDA (PDA: Personal Digital Assistant), a digital camera, a digital video camera, a portable game console, or a notebook computer, for example. Moreover, the same advantages as those of the foregoing embodiment can still be obtained in any case.

Lastly, the foregoing embodiment is one example of the present disclosure. Accordingly, the present disclosure is not limited to the foregoing embodiment, and various modifications, combinations, and other embodiments may occur depending on design or other factors while remaining within the scope of the claims of the present disclosure or their equivalents. This is naturally understood by those skilled in the art.

1. An information processing apparatus comprising:
a display that displays a three-dimensional (3D) image including a left-eye image and a right-eye image;
a sensor unit that detects a proximity operation of an object by detecting detection data corresponding to a distance between the sensor unit and the object; and
a controller that adjusts a difference between the left-eye image and the right-eye image of the 3D image displayed by the display based on the detection data detected by the sensor unit.

2. The information processing apparatus of claim 1, wherein
the sensor unit is a touch panel disposed on a surface of the display that detects an electrostatic capacitance as the detection data.

3. The information processing apparatus of claim 2, wherein
the controller determines the distance between the sensor unit and the object based on the detected electrostatic capacitance.

4. The information processing apparatus of claim 2, wherein
the touch panel includes a substrate layer including an insulator film, an electrode layer arranged below the insulator film, and a control integrated circuit.

5. The information processing apparatus of claim 4, wherein
the touch panel includes a plurality of mosaic electrode patterns each including two layers of transparent electrodes in each of vertical and horizontal directions in the electrode layer.

6. The information processing apparatus of claim 1, wherein
the sensor unit includes a plurality of proximity sensors disposed on an exterior surface of the information processing apparatus.

7. The information processing apparatus of claim 6, wherein
the detection data indicates that the object is detected by at least one of the plurality of proximity detectors.

8. The information processing apparatus of claim 7, wherein
the controller determines the distance between the sensor unit and the object based on the detection data indicating that the object is detected by at least one of the plurality of proximity detectors.

9. The information processing apparatus of claim 1, further comprising:
a memory that stores a plurality ranges corresponding to the detection data, each of the ranges corresponding to one of a plurality of operation layers corresponding to the proximity operation.

10. The information processing apparatus of claim 9, wherein
the controller determines an operation layer corresponding to the proximity operation by comparing the detected detection data to each of the plurality of ranges stored by the memory.

11. The information processing apparatus of claim 10, wherein
the controller adjusts the difference between the left-eye image and the right-eye image of the 3D image displayed by the display based on the determined operation layer.

12. The information processing apparatus of claim 10, wherein
a first range of the detection data corresponds to a first operation layer and a second range of the detection data corresponds to a second operation layer, and
the first range of detection data indicates that the distance between the sensor unit and the object is less than the distance between the sensor unit and the object indicated by the second range of detection data.

13. The information processing apparatus of claim 12, wherein
the controller adjusts the distance between the left-eye image and the right-eye image to be a first distance when the controller determines the operation layer to be the first operation layer and adjusts the distance between the left-eye image and the right-eye image to be a second distance when the controller determines the operation layer to be the second operation layer.

14. The information processing apparatus of claim 13, wherein
the first distance is less than the second distance.

15. The information processing apparatus of claim 10, wherein
a first range of detection data corresponds to a first operation layer, a second range of detection data corresponds to a second operation layer, and a third range of detection data corresponds to a third operation layer,
the first range of detection data indicates that the distance between the sensor unit and the object is less than the distance between the sensor unit and the object indicated by the second range of detection data, and
the second range of detection data indicates that the distance between the sensor unit and the object is less than the distance between the sensor unit and the object indicated by the third range of detection data.

16. The information processing apparatus of claim 15, wherein
the controller adjusts the distance between the left-eye image and the right-eye image to be a first distance when the controller determines the operation layer to be the first operation layer, adjusts the distance between the left-eye image and the right-eye image to be a second distance when the controller determines the operation layer to be the second operation layer, and adjusts the distance between the left-eye image and the right-eye image to be a third distance when the controller determined the operation layer to be the third operation layer.

17. The information processing apparatus of claim 16, wherein
the first distance is less than the second distance and the second distance is less than the third distance.

18. A method performed by an information processing apparatus, the method comprising:
displaying, by a display of the information processing apparatus, a three-dimensional (3D) image including a left-eye image and a right-eye image;
detecting, by a sensor unit of the information processing apparatus, a proximity operation of an object by detecting detection data corresponding to a distance between the sensor unit and the object; and
adjusting, by a processor of the information processing apparatus, a difference between the left-eye image and the right-eye image of the 3D image displayed by the display based on the detection data detected by the sensor unit.

19. A non-transitory computer-readable medium including computer program instructions, which when executed by an information processing apparatus, cause the information processing apparatus to perform a method comprising:
displaying a three-dimensional (3D) image including a left-eye image and a right-eye image;
detecting a proximity operation of an object by detecting detection data corresponding to a distance between the sensor unit and the object; and
adjusting a difference between the left-eye image and the right-eye image of the 3D image based on the detection data.
